(19) United States
(12) Patent Application Publication
(10) Pub. No.: US 2005/0198321 A1
(43) Pub. Date: Sep. 8, 2005

(54) Method and system for workgroup presence availability

(76) Inventor: Jeffrey M. Blohm, Menlo Park, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/954,440

(22) Filed: Sep. 29, 2004

Related U.S. Application Data
(63) Continuation-in-part of application No. 10/673,390, filed on Sep. 29, 2003.

(51) Int. Cl. G06F 15/16

(52) U.S. Cl. 709/228; 709/205

(57) ABSTRACT

Embodiments provide a system, methods, apparatus, means, and computer program code for defining a workgroup; receiving one or more user presence contexts for users in said workgroup; and deriving a workgroup presence context from said one or more user contexts.

### CROSS REFERENCE TO RELATED APPLICATIONS

The present invention is a continuation-in-part of co-pending, commonly assigned U.S. patent application titled METHOD AND SYSTEM FOR MAPPING IDENTITY CONTEXT TO DEVICE CONTEXT, Ser. No. 10/673,390, filed Sep. 29, 2003, which is hereby incorporated by reference in its entirety as if fully set forth herein.

### FIELD OF THE INVENTION

The present invention relates to telecommunications systems and, to an improved telecommunications presence system.

### BACKGROUND OF THE INVENTION

Modern telecommunications systems allow users to make use of multiple devices, such as a telephone, personal digital assistant (PDA), cell phone, computer, etc. Thus, the person may be represented by or associated with the different types of devices.

A second person may attempt to contact the first person via email, instant message communication, telephone call, etc. The ability of the second person to contact or communicate with the first person may be limited by the availability of the device(s) chosen by the second person and/or the availability of the first person.

For example, if the first person currently is using his or her telephone, the second person may not be able to contact the first person via telephone. However, the second person may be able to contact the first person via an email message sent to the first person's computer. In addition, if the first person is on vacation or out of the office, the second person may not be able to reach the first person via a telephone or computer located at the first person's office, but may be able to reach the first person via cellular telephone.

As another example, if the first person is “busy,” the second person might not be able to reach the first person at all, even if all of the devices associated with the first person are currently available. If the second person can determine the availability of the first person and/or the availability of one or more devices associated with the first person, the second person may be able to make better choices regarding how to communicate with the first person.

In addition, telecommunications systems allow for the grouping of multiple users in units referred to as “workgroups.” A “workgroup” may be thought of as a group of people who work together to achieve business objectives. For example, members of an enterprise's information technology group could be members of a single workgroup that provides support to the organization. When other members of the organization need computer help, they may not need a specific member of the workgroup, so long as a member is available. The usefulness of the computer help would be enhanced if the party needing help could determine if members of the workgroup were available.

As such, there is a need for a system, method, apparatus, means, and computer program code for allowing and enabling users to view individual and workgroup presence status.

### SUMMARY OF THE INVENTION

These and other drawbacks in the prior art are overcome in large part by a system and method according to embodiments of the present invention.

A method according to embodiments of the present invention includes defining a workgroup; receiving one or more user presence contexts for users in said workgroup; and deriving a workgroup presence context from said one or more user contexts. In certain embodiments of the present invention, the deriving includes evaluating a presence status of a predetermined number of members of said workgroup. In certain embodiments, the evaluating a presence status includes evaluating a media presence value for individual media types. In certain embodiments, the evaluating a presence status includes evaluating an aggregated media presence value for a given media type. Finally, in certain embodiments, the method includes making the workgroup presence information available to all registered and/or interested parties.

A telecommunications system according to embodiments of the present invention includes a plurality of users defining a workgroup; and a presence server configured to monitor presence contexts of said plurality of users, said presence server including a workgroup presence control unit configured to monitor a workgroup presence, said workgroup presence derived from user presence contexts.

A workgroup presence may be defined by a user presence of a predetermined number of users, wherein the number is user-programmable. A workgroup presence may be defined over a particular medium or over a plurality of media.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE FIGURES

The accompanying drawings, which are incorporated in and form a part of the specification, illustrate embodiments of the invention.

FIG. 1 is a block diagram of a system according to some embodiments;

FIG. 2 is another block diagram of the system according to some embodiments;

FIG. 3 is a flowchart of a method in accordance with some embodiments;

FIG. 4 is a representative example of a mapping table for use in mapping an identity context to a device context;

FIG. 5 is another flowchart of a method in accordance with some embodiments;

FIG. 6 is another flowchart of a method in accordance with some embodiments;

FIG. 7 is another flowchart of a method in accordance with some embodiments;

FIG. 8 is a representative example of workgroups according to embodiments of the present invention;

FIG. 9 is a representative example of a table of workgroup contexts according to an embodiment of the present invention;

FIG. 10 is a representative example of workgroup context mapping according to an embodiment of the present invention;

FIG. 11 is a block diagram of a system according to embodiments of the present invention;

FIG. 12 is a flowchart illustrating operation of embodiments of the prewent invention;

FIG. 13 is a flowchart illustrating operation of embodiments of the present invention;

FIG. 14 is a flowchart illustrating operation of embodiments of the present invention;

FIG. 15 is a block diagram of a user device according to embodiments of the present invention; and

FIG. 16 is a block diagram of a server that may implement one or more of the components of FIG. 1 and/or FIG. 11 and/or one or more elements of the methods described herein.

### DESCRIPTION OF SPECIFIC EMBODIMENTS

Context Mapping

There is a market opportunity for systems, means, computer code, and methods that allow and enable mapping of device oriented contexts to identity oriented contexts and/or allowing mapping of identity oriented contexts to device oriented contexts. For example, in some embodiments an identity may be or include an individual person or a group of people. An identity context for the identity could be a state of “in meeting,” “on vacation,” “in the office,” “out of the office,” “roaming,” “offline,” “online,” “unknown,” “on business trip,” “in transit,” “mobile,” etc. Thus, the identify context describes the implied availability of the identity. An identity context then may allow an identity to have an overall state that describes the work or non-work state that that the identity is in.

An identity context state of “offline” for an identity may indicate that the identity is generically offline for any number of reasons. Thus, a potential communicator with this identity should not expect to get any live contact.

An identity context state of “online” for an identity may indicate that the identity is generically online. Thus, a potential communicator with this identity could expect some chance of communicating with the identity by voice, instant messaging, etc.

An identity context state of “in meeting” for an identity may indicate that the identity is not at his or her desk, but elsewhere attending a meeting. Thus, a potential communicator with this identity might expect to be able to get voice or instant messaging contact only in urgent situations.

An identity context state of “in the office” for an identity may indicate that the identity is in his or her office. Thus, a potential communicator may be able to reach the identity via voice or instant message communication with devices in the identity's office or via an email message sent to a device in the identity's office.

An identity context state of “roaming” for an identity may indicate that the identity is in the office, but not necessarily at his or her desk. However, the identity may be available via a cellular telephone or other mobile device associated with the identity.

An identity context state of “do not disturb” or “DND” for an identity may indicate that the identity is not accepting telephone calls, instant message communications, and/or other forms of communication.

An identity context state of “in transit” for an identity may indicate that the identity is currently out of the office, away from home, and/or mobile on the way to a destination. This state also may imply that the identity has a specific mobile device (e.g., cellular telephone, PDA) and can be contacted via one or both of those devices.

An identity context state of “mobile” for an identity may indicate that the identity is working or located at a more permanent mobile environment. This context may imply that identity may be reachable via a portable or mobile device or a communication device associated with the permanent mobile environment.

In some embodiments, different applications may be used to set, monitor or change an identity context for an identity (either group or individual). For example, a calendar program, telephone user interface, graphical user interface, plug-in, etc. may allow or enable an identity to set or change an identity context for the identity manually or automatically.

An identity may have one or more associated devices. For example, a person may have an associated office telephone, a home telephone, a cellular telephone, computer, personal digital assistant (PDA), etc. Each device may have an associated device context. For example, the person's office telephone may be busy, set to “do not disturb,” automatic call forwarding, offline, etc. Context for a device may describe the work or non-work state, and/or the availability or non-availability state, that the device is in. In some embodiments, potential device contexts may include “available,” “non-available,” “busy,” “away,” “unknown,” “partially available” (e.g., a device may be “busy” on a voice channel but available on an instant messaging channel), “be right back,” “present,” not present,” etc. In some embodiments, different applications may be used to set, monitor or change a device context for a device. For example, software operating on a computer may allow an identity to indicate manually or automatically that the computer is unavailable for email, instant messaging, file transfer or other communications at the current time, at a specific later time, during a time range, etc. As another example, a wireless and instant messaging capable PDA may be considered as having a device context as “available” by a presence and availability service when the PDA is online and a device context of “unavailable” by the presence and availability service when the PDA is offline.

However, when an identity context changes, it may not be reflected at the device context level. Thus, while a user may set his or her identity context to, for example, “DND”, a program looking at or monitoring the devices would still believe that the identity was available for a telephone call. Mapping the identity context of “DND” to a similar device context for each of the identity's associated devices allows for a truer representation of identity context to device context oriented applications.

When a device context for a device is changed, it may represent an identity in a single media channel system. For example, in a telephone system when an identity sets his or her device context to “DND”, it means that the identity is in a state of “DND” as well. If this is the desired operation, a device context such as “DND” can be mapped to an identity context such as “DND”. Mapping the device context of “DND” to a similar identity context allows for a truer representation of identity context to identity context oriented applications.

As will be described in more detail below, there may be situations in which a change in a device context for a device associated with an identity leads to a change in an identity context for the identity, and vice versa. For example, a person may set an office telephone to “do not disturb”. Thus, the device context for the telephone is set to “do not disturb”. However, the person may be reachable or available via other devices associated with the person. In some circumstances, when the person sets the telephone to “do not disturb” (e.g., to a device context of “do not disturb” or “busy”), what the person may really want to do is reflect that he or she as an overall user is in a “do not disturb” mode. That is, his or her identity context is “do not disturb” and, as a result, the person is not reachable or availability via any of the devices associated with the person. When the person sets the telephone to “do not disturb,” software in the telephone, or another application monitoring the state of the telephone, may indicate to a context agent that the telephone's device context has changed.

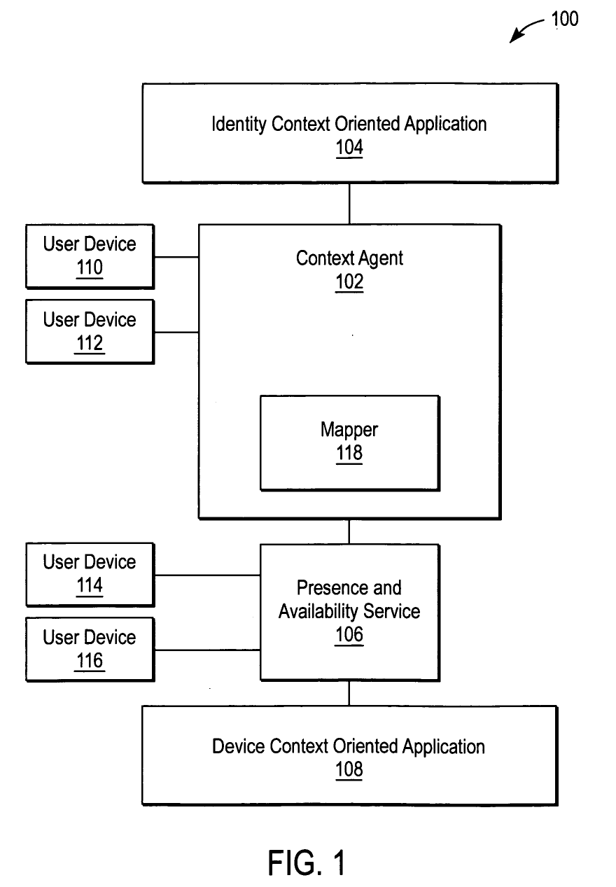

Now referring to FIG. 1, an exemplary system 100 is illustrated according to some embodiments. The system 100 includes a context agent 102 that may be connected to or in communication with an identity context oriented application 104 and a presence and availability service 106. The system 100 also may include a device context oriented application 108 connected to or in communication with the presence and availability service 106.

User devices, such as the user devices 110, 112, may be connected to or in communication with the context agent 102. Similarly, user devices, such as user devices 114, 116, may be connected to or in communication with the presence and availability service 106. In some embodiments, a user device may be or include such things as telephones, cellular telephones, PDAs, computers, etc. For example, the user devices 114, 116, may be personal computers implementing the Windows XP™ operating system and the Windows Messenger™ instant messenger system. In addition, the user devices 114, 116 may include telephony and other multimedia messaging capability using, for example, peripheral cameras, Webcams, microphones and speakers (not shown) or peripheral telephony handsets, such as the Optipoint™ handset available from Siemens Information and Communication Networks.

In some embodiments, the system 100 may include other hardware and/or software components (e.g., gateways, proxy servers, registration servers, presence servers, redirect servers, databases, applications), such as, for example, hardware and software used to support a SIP or other protocol based infrastructure for the system 100 and allow registration of SIP devices in the system 100.

The context agent 102 may monitor the identity context of one or more identities and/or the device context of one or more devices. In some embodiments, the context agent 102 may provide or include an application interface that supports identity context, device context, device presence, and/or other functions. Applications may monitor, access and/or query the context agent 102 for identity context and/or device context information.

In some embodiments, the context agent 102 may be able to receive, retrieve, or otherwise obtain information regarding an identity and/or a device associated with the identity, such as calendar information, schedule information, location information, configuration information, context information, etc.

In some embodiments, the context agent 102 may provide the information to the identity context oriented application 104 upon request, periodically, or in accordance with some other plan or procedure. In addition, in some embodiments, the context agent 102 may provide information regarding device context. For example, an application may query the context agent 102 to monitor or determine the device context of one or more devices. In some embodiments, an application may set or request a change for, either an identity context and/or a device context. For example, an application that sets an identity context for an identity to “in meeting” may set the device context for the identity's desk telephone to “offline” for both voicemail and instant messaging.

The context agent 102 may be implemented in hardware and/or software operating on one or more servers, computer systems, host or mainframe computers, workstations, etc. In some embodiments the context agent 102 may be operating on some or all of the same device(s) as other components in the system 100.

As will be discussed in more detail below, in some embodiments the context agent 102 may include or be in communication with a mapper component 118 that allows the context agent 102 to map device context information for a device (e.g., the user device 114) to identity context information for an identity associated with the device. The context agent 102 then may provide updated or new identity context information for the identity to the identity context oriented application 104. In addition, the mapper 118 may map identity context information for an identity to device context information for one or more devices associated with the identity. The context agent 102 then may provide the updated or new device context information for the device to the presence and availability service 106. In some embodiments, the context agent 102 may register with the presence and availability service 106.

In some embodiments, the mapper 118 may be implemented as part of the context agent 102. In other embodiments, the mapper 118 may be implemented separately from the context agent 102 and be in communication with both the context agent 102 and the presence and availability service 106. In such embodiments, the mapper 118 may be implemented in hardware and/or software operating on one or more servers, computer systems, host or mainframe computers, workstations, etc. and may be operating on some or all of the same device(s) as other components in the system 100 instead of the context agent 102.

The identity context oriented application 104 may be or include an application that uses, collects, refers to, etc. information regarding the identity context of one or more identities. For example, an identity context oriented application may be or include software that allows identities to provide information regarding their availability, location, etc. In some embodiments, a user device, server, host or mainframe computer, workstation, etc. may include an identity context oriented application or have one operating or residing on it. The identity context oriented application 104 may be implemented in hardware and/or software operating on one or more servers, computer systems, host or mainframe computers, workstations, etc. In some embodiments the identity context oriented application 104 may be operating on some or all of the same device(s) as other components in the system 100.

The presence and availability service 106 may be or include an application that monitors the presence and availability of devices. That is, the presence and availability service 106 monitors the device context of one or more devices. In some embodiments, one or more of the devices may be associated with the identities whose context is used or monitored by the identity context oriented application 104. The presence and availability service 106 may be implemented in software operating on one or more servers, computer systems, host or mainframe computers, workstations, etc. In some embodiments the presence and availability service 106 may be operating on some or all of the same device(s) as other components in the system 100.

In some embodiments, the presence and availability service 106 may be or include an application that communicates with or is connected to one or more registered devices (e.g., devices 114, 116), that allows devices to register with the system 100 or helps facilitate their registration, etc. For example, in a SIP environment, the devices 114, 116 may be registered with the system 100 and may show up or be described in registration databases as being assigned to particular identities. The context agent 102 may register with the presence and availability service 106 and receive device context and/or other information from the presence and availability service regarding the devices 114, 116.

In some embodiments, the presence and availability service 106 may provide device context information to the device context oriented application 108 upon request, periodically, or in accordance with some other plan or procedure. In some embodiments, the presence and availability service may interact with an instant messaging system. For example, the instant messaging system may be embodied as Microsoft Windows Messenger™ software or other instant messaging system.

The device context oriented application 108 may be or include an application that uses, collects, refers to, etc. information regarding the device context of one or more device (e.g., the user device 114). For example, a device context oriented application may be or include software that allows identities to provide or request information regarding the availability of devices associated with the identities, etc. In some embodiments, a user device, server, host or mainframe computer, workstation, etc. may include a device context oriented application or have one operating or residing on it. The device context oriented application 108 may be implemented in hardware and/or software operating on one or more servers, computer systems, host or mainframe computers, workstations, etc. In some embodiments the device context oriented application 108 may be operating on some or all of the same device(s) as other components in the system 100.

The terms “identity context,” “device context,” “context agent,” “mapper,” “presence and availability service,” “identity context oriented application,” and “device context oriented application” are used herein merely for purposes of convenience and ease of explanation and no specific limitations are intended or implied by the use of these terms herein.

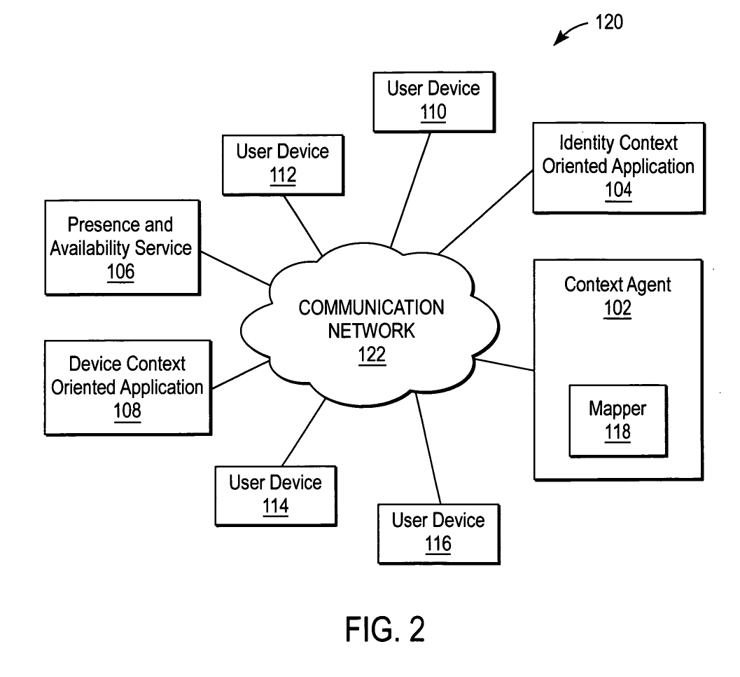

In some embodiments, one or more of the components of the system 100 may be connected or in communication with each other via a communication network. For example, now referring to FIG. 2, a system 120 including the components of the system 100 is illustrated, wherein some or all of the components are in communication via a network 122. The network 122 may be or include the Internet, the World Wide Web, a local area network, or some other public or private computer, cable, telephone, client/server, peer-to-peer, or communications network or intranet. In some embodiments, a communications network also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL connections, etc. Moreover, as used herein, communications include those enabled by wired or wireless technology. In some embodiments, some or all of the network 122 may be implemented using a TCP/IP network and may implement voice or multimedia over IP using, for example, the Session Initiation Protocol (SIP).

Context Mapping Process Description

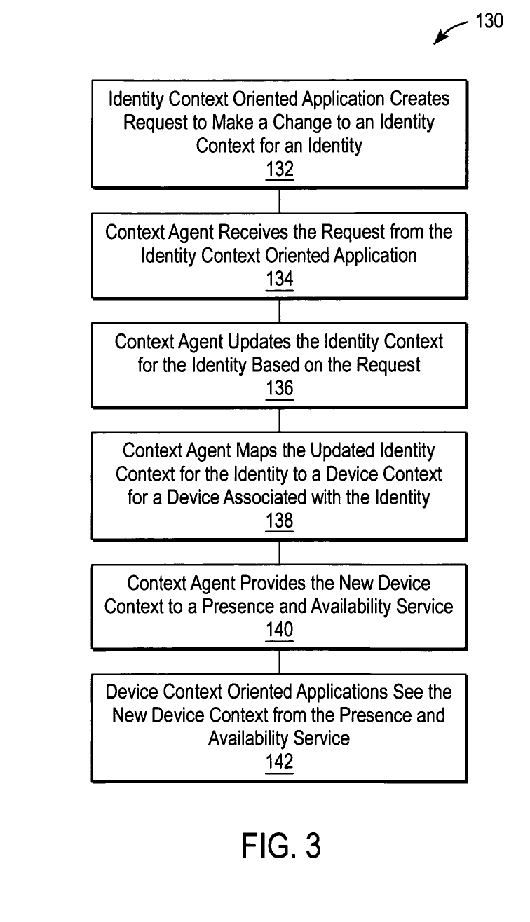

Reference is now made to FIG. 3, where a flow chart 130 is shown which represents the operation of a first embodiment. The method 130 is particularly well suited for situations where an identity context for an identity is to be mapped to a device context for one or more devices associated with the identity. The particular arrangement of elements in the flow chart 130 is not meant to imply a fixed order to the elements; embodiments can be practiced in any order that is practicable.

Processing begins at 132 during which the identity context oriented application 104 creates a request to make a change to an identity context for an identity. For example, an identity context may change from “in the office” to “in a meeting” or from “online” to “offline”.

In some embodiments, the identity context oriented application 104 may create the request based on the action of an identity, other application, communication received from a user device, etc. The identity context oriented application 104 may provide the request directly or indirectly to the context agent 102.

During 134, the context agent 102 receives or otherwise obtains the request created by the identity context oriented application 104. The request may be or include data, a data stream or other communication signal receivable or obtainable by the context agent 102.

During 136, the context agent 102 updates the identity context for the identity based on the request. The context agent 102 may store some or all of the identity context information in a local or remote database, file, log, or other electronic resource.

During 138, the context agent 102 maps the updated identity context for the identity to a device context for one or more devices (e.g., the user device 110 or the user device 114) associated with the identity. As previously discussed above, in some embodiments, the context agent 102 may include or have access to the mapper component 118 to conduct such mapping or other conversion.

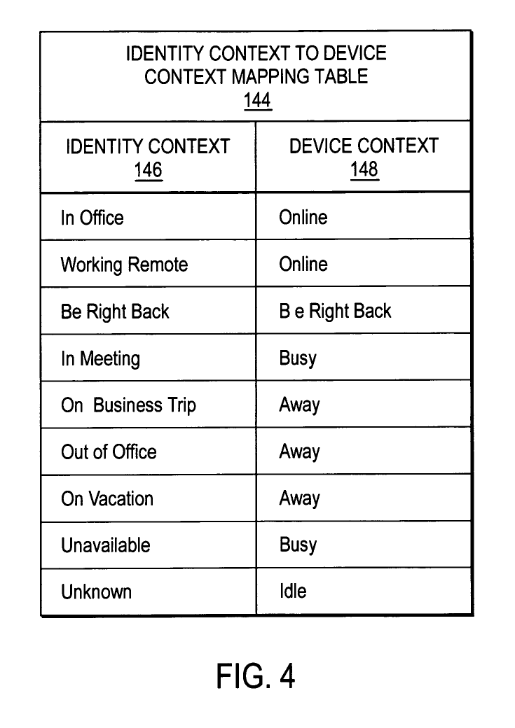

In some embodiments, the context agent 102 may have access to or use a mapping table or other resource that indicates the mapping of an identity context to a device context. For example, as illustrated in mapping table 144 in FIG. 4, identity contexts listed in column 146 may be mapped to corresponding device contexts in column 148 for one or more devices associated with the identity. More specifically, if an identity context changes from “in office” to “out of office” for an identity, a device context for a device should be mapped to “away” based on the new identity context of “out of office”.

In some embodiments, mapping of device context to identity context, and vice versa, may be done in other ways. For example, a system administrator may establish, update, modify, etc. one or more mapping tables. As another example, an identity or group of identities may establish, update, modify, etc. one or more mapping tables. As a third example, a system administrator, identity, group, etc. may establish one or more rules, heuristics, procedures, algorithms, etc. for establishing or using a mapping table, for using one or more inputs or retrieved data to create a mapping table, etc.

In some embodiments, mapping an identity context to a device context may vary for different devices associated with an identity. For example, an identity context of “out of office” may be mapped to “away” for a computer at the identity's office and “online” for a wireless PDA associated with the identity. Thus, different devices may use different identity context to device context mapping tables, conventions, or rules.

In some embodiments, if different mapping tables, conventions, or rules are used for difference devices, the context agent 102 may need to identity or determine one or more devices associated with the identity in order to change their device context properly. In some embodiments, if only one type of device is assumed to be associated with an identity, if multiple types of devices can have the same device contexts, if the context agent 102 does not know the device for which it is mapping an identity context, or if is not feasible for the context agent 102 to know or determine the types of devices that may be associated with an identity, a default mapping table or convention may be used to map the identity context to a device context. Thus, the context agent 102 may not need to determine the specific type of device.

Referring back to FIG. 3, during 140, the context agent 102 provides information or other data regarding the device context for the device to the presence and availability service 106, which may be or include the presence and availability service 106 “seeing,” receiving, retrieving, querying, requesting, accessing, or otherwise obtaining the device context information from the context agent 102. As previously mentioned above, the presence and availability service 106 may be or include an application that monitors the presence and availability of devices and, as a result, monitors the device context of one or devices.

After receiving the new device context information from the context agent 102, the presence and availability service 106 may update its device context information. This may result in a change in the device context previously associated with the device associated with the identity whose identity context changed. For example, if an identity context changes from “in office” to “out of office”, a device context for a device associated with the identity may change from “online” to “away”.

In some embodiments, the presence and availability service 106 may provide information regarding the new device context to a device context oriented application, such as the device context oriented application 108 or a device context oriented application operating on a user device (e.g., the user device 114) or another device.

During 142, a device context oriented application, such as the device context oriented application 108 or a device context oriented application operating on a user device (e.g., the user device 114) or another device, may “see”, retrieve, query, obtain, or otherwise have access to some or all of the updated device context information managed by the presence and availability service 106.

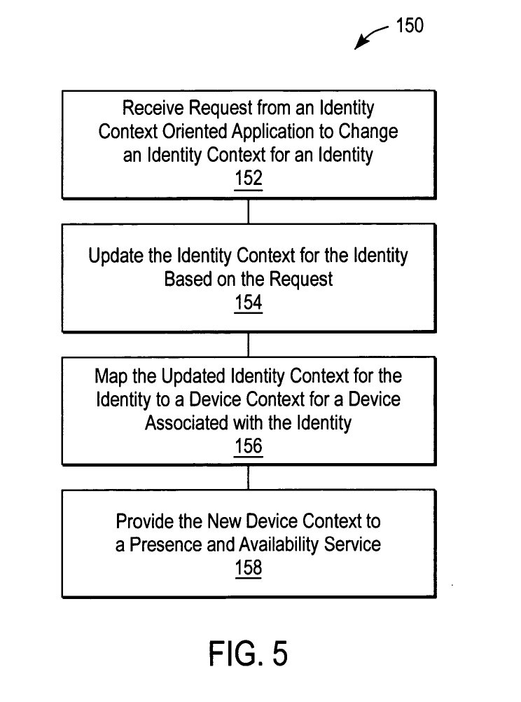

Reference is now made to FIG. 5, where a flow chart 150 is shown which represents the operation of a second embodiment. The particular arrangement of elements in the flow chart 150 is not meant to imply a fixed order to the elements; embodiments can be practiced in any order that is practicable. In some embodiments, some or all of the elements of the method 150 may be performed or completed by the context agent 102

Processing begins at 152 during which the context agent 102 receives or otherwise obtains a request from an identity context oriented application (e.g., identity context oriented the application 104) to change an identity context for an identity.

During 154, the context agent 102 updates or otherwise modifies the identity context for the identity based on the request.

During 156, the context agent 102 maps the updated identity context for the identity to one or more device contexts for one or more devices associated with the identity. In some embodiments, the context agent 102 may need to identity or otherwise determine one or more device associated with the identity, use or access a default or other mapping table, and/or identity or otherwise determine a device context associated with one or more devices that are associated with the identity.

In some embodiments, during 158, the context agent 102 may provide some or all of the new device context information to the presence and availability service 106 or allow the presence and availability service 106 to “see,” retrieve, access, query, request or otherwise obtain the device context information.

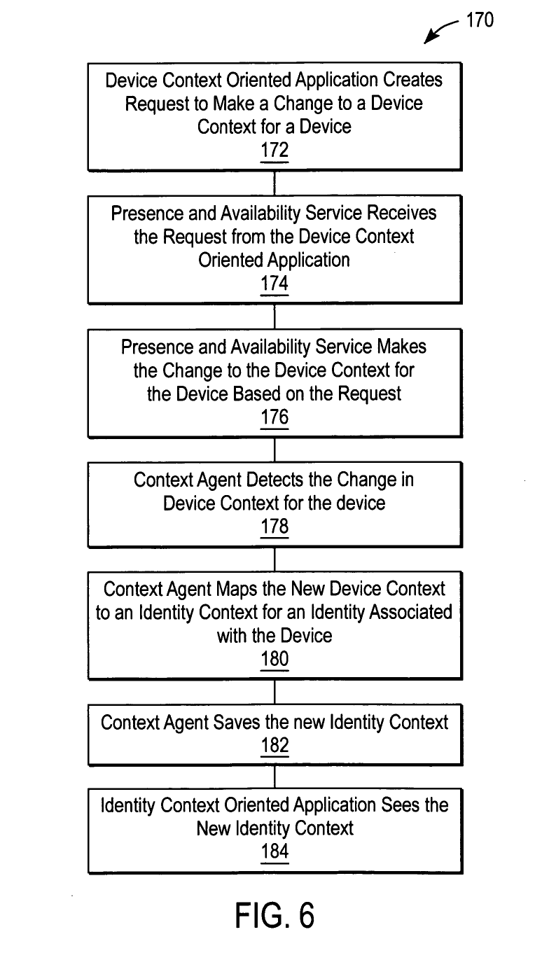

Reference is now made to FIG. 6, where a flow chart 170 is shown which represents the operation of a third embodiment. The method 170 is particularly well suited for situations where a device context for a device associated with an identity is to be mapped to an identity context for the identity. The particular arrangement of elements in the flow chart 170 is not meant to imply a fixed order to the elements; embodiments can be practiced in any order that is practicable.

Processing begins at 172 during which the device context oriented application 108 creates a request to make a change to a device context for a device (e.g., the user device 114) associated with an identity. For example, the device context may change from “online” to “busy” or from “online” to “away”. For example, monitoring software, which may be acting as a device context oriented application, may monitor the state of one or more telephones and report changes in the states to the context agent 102 or another application (e.g., the context oriented device application). Instant messaging applications may update the states of one or more devices via the presence and availability service 106.

In some embodiments, the device context oriented application 108 may create the request based on the action of an identity, other application, communication received from a user device, etc. The device context oriented application 108 may provide the request directly or indirectly to the presence and availability service 106.

During 174, the presence and availability service 106 receives or otherwise obtains the request created by the device context oriented application 108. The request may be or include data, a data stream or other communication signal receivable or obtainable by the presence and availability service 106.

During 176, the presence and availability service 106 updates the device context for the device based on the request. The presence and availability service 106 may store some or all of the device context information in a local or remote database, file, log, or other electronic resource.

During 178, the context agent 102 detects or otherwise “sees” the change in the device context for the device. In some embodiments, the context agent 102 may receive a request from the presence and availability service 106 to change a device context. In other embodiments, the context agent 102 may monitor the presence and availability service 106 for changes in device contexts. In still other embodiments, the presence and availability service 106 may provide data to the context agent 102 indicative of a change in device context for one or more devices.

During 180, the context agent 102 maps the new or different device context for the device to an identity context for the identity associated with the device. If a device context changes from “online” to “offline” for an identity, an identity context for the associated identity could be mapped to “unavailable”. As previously discussed above, in some embodiments, the context agent 102 may include, use, or have access to the mapper component 118 to conduct such mapping or other conversion.

In some embodiments, the context agent 102 may have access to or use a mapping table that indicates the mapping of a device context to an identity context, in a manner similar to mapping table 144 illustrated in mapping table 144 in FIG. 4. In some embodiments, mapping a device context to an identity context may vary for different devices associated with an identity. Thus, different devices may use different identity context to device context mapping tables.

During 182, the context agent 102 may store or otherwise save the new identity context information. For example, in some embodiments, the context agent 102 may store some or all of the identity context information in a local or remote database, file, log, or other electronic resource.

During 184, an identity context oriented application, such as the identity context oriented application 104 or an identity context oriented application operating on a user device (e.g., the user device 110) or another device, may “see”, retrieve, or otherwise have access to some or all of the updated identity context information managed by the context agent 102. In some embodiments, the context agent 102 may provide information or other data regarding the identity context to another device or application, which may be or include the other device or application retrieving, querying, requesting, accessing, or otherwise obtaining the identity context information from the context agent 102.

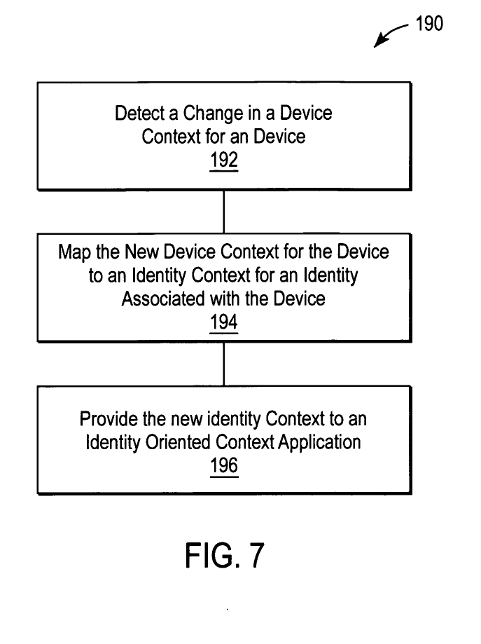

Reference is now made to FIG. 7, where a flow chart 190 is shown which represents the operation of a fourth embodiment. The particular arrangement of elements in the flow chart 190 is not meant to imply a fixed order to the elements; embodiments can be practiced in any order that is practicable. In some embodiments, some or all of the elements of the method 150 may be performed or completed by the context agent 102

Processing begins at 192 during which the context agent 102 detects a change in a device context for a device, as previously discussed above.

During 194, the context agent 102 maps the new or changed device context to an identity context for an identity associated with the device. In some embodiments, different identities may use different mapping tables, rules, or conventions. In some embodiments, different device contexts for different devices may have different identity context associated with them. In some embodiments, the context agent may need to determine the identity, the identity contexts available for or usable with the identity, the appropriated mapping table, rule(s) or convention, etc.

During 196, the context agent 102 may provide some or all of the new identity context information to an identity context oriented application to allow an identity context oriented application to “see”, retrieve, access, query, request or otherwise obtain the identity context information.

Workgroup Context

As noted above, in certain telecommunications systems, workgroups of pluralities of users may be defined within the system; embodiments of the present invention may be used to set and make use of workgroup context information. A workgroup may be set up, for example, to be callable and share a common distribution rule across various media, including voice, text messaging, e-mail, fax, video, etc. More generally, a group of users may form a workgroup, for example, to provide a service to other people in an organization. Workgroup presence/context information according to embodiments of the present invention allows other parties to determine the status of the workgroup prior to initiating communications.

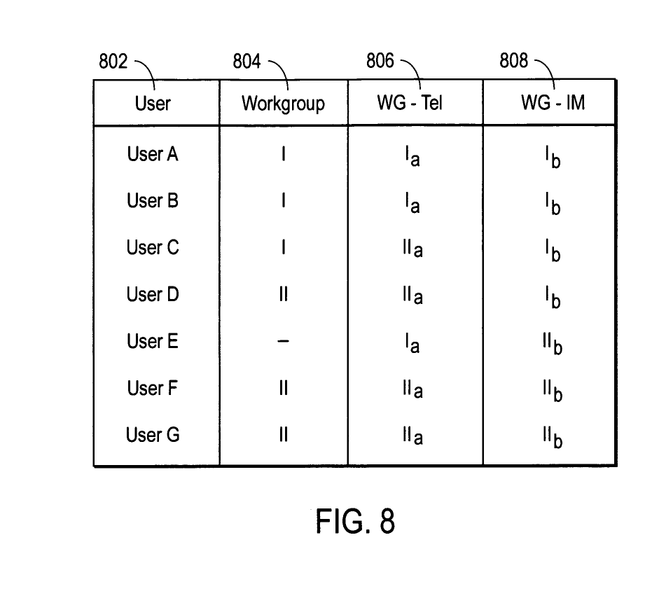

The workgroups may be set across a plurality of media or only across a single medium. Also, a user may be a member of a plurality of different workgroups. For example, FIG. 8 is a table illustrating a plurality of users and exemplary workgroup assignments. Column 802 lists exemplary users: User A, User B, User C, User D, User E, User F, and User G. Column 804 shows exemplary “global” workgroups to which the users may belong. The users that are members of a global workgroup are deemed to be members for all media, e.g., telephone, Instant Messaging, E-mail, etc. That is, if a member of a global workgroup, the user will be a member of a corresponding telephone workgroup, Instant Messaging workgroup, e-mail workgroup. In the example illustrated, User A, User B, User C are members of Workgroup I. User D, User F and User G are members of Workgroup II. User E is a member of no global workgroups. It is noted that, while particular workgroups are shown, different workgroups are possible. For example, users may be members of more than one workgroup; similarly, workgroups may include more than three members.

Column 806 illustrates membership in an exemplary telephone workgroup. In column 806, User A, User B, and User E are members of Workgroup Ia, and User C, User D, User F, and User G are members of Workgroup IIa. Similarly, column 808 illustrates exemplary Instant Messaging workgroups. In particular, User A, User B, User C, and User D are members of Workgroup Ib and User E, User F, and User G are members of Workgroup IIb.

As noted above, embodiments of the present invention define a workgroup context. The workgroup context may be based on the device or identity contexts of members of the workgroup, similar to those discussed above. The workgroup context may also be based on an “aggregated” media context. For example, a user may have several telephones registered with the presence and availability system; if at least one of them is online, the user may be defined to have an aggregated telephone state of online. Similarly, the user may have several IM accounts; if he is available on one, he may be considered to be online for IM.

For simplicity of discussion, it will be assumed that the individual device and aggregated media contexts can assume Offline, Unknown, Online, and Busy contexts, similar to those defined above. It is noted that other device and/or aggregated media contexts may be defined, and that not all devices can necessarily assume a particular context; similarly, the workgroup context system of embodiments of the present invention can function in a system using the identity contexts, or identity/device context mapping. Further, aggregated media contexts can be subject to identity mapping similar to that described above.

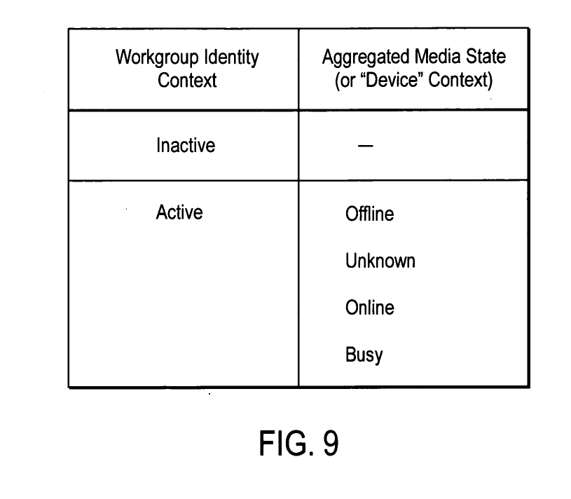

In embodiments of the present invention, these device contexts or media presence values can be used to map a workgroup “device” context for particular media, as well as an “Identity Context,” as shown in FIG. 9 Typically, the Workgroup Identity Context 902 may be set by the user or an administrator and can be defined as workgroup “Active” or workgroup “Inactive.” An active workgroup can assume a workgroup device or aggregated media context 904 for individual media. Exemplary workgroup device and aggregated media contexts include Offline, Unknown, Online, and Busy. The mapping of individual device or aggregated media contexts to a workgroup context may be based on the number of members of the workgroup having a particular state. For example, a workgroup may be deemed “Online” if a predetermined number of members are Online.

Exemplary workgroup context definitions follow:

A workgroup context of “Offline” indicates that there are no eligible workgroup members accessible.

A workgroup context of “Unknown” indicates that there are not enough eligible workgroup members online to meet a predetermined threshold.

A workgroup context of Online indicates that there are a sufficient number of workgroup members online to meet a predetermined threshold.

A workgroup context of “Busy” indicates that all eligible workgroup members are busy.

As noted above, in certain embodiments of the present invention, predetermined numbers of members of a workgroup having a particular user presence context are used to define the corresponding workgroup context. While the numbers may be set by the user or a system administrator, a default rule may be provided. An exemplary default for voice would be that at least one workgroup member must be available for the workgroup to be marked as available for voice communication. Similarly, for Instant Messaging and E-mail, a default might be that at least one workgroup member should be online before the workgroup is indicated to be online for e-mail and instant messaging. It is noted that other defaults or user-selected thresholds may be chosen; e.g., a rule might be that a majority of members or a certain percentage of members should be available for the workgroup to be available.

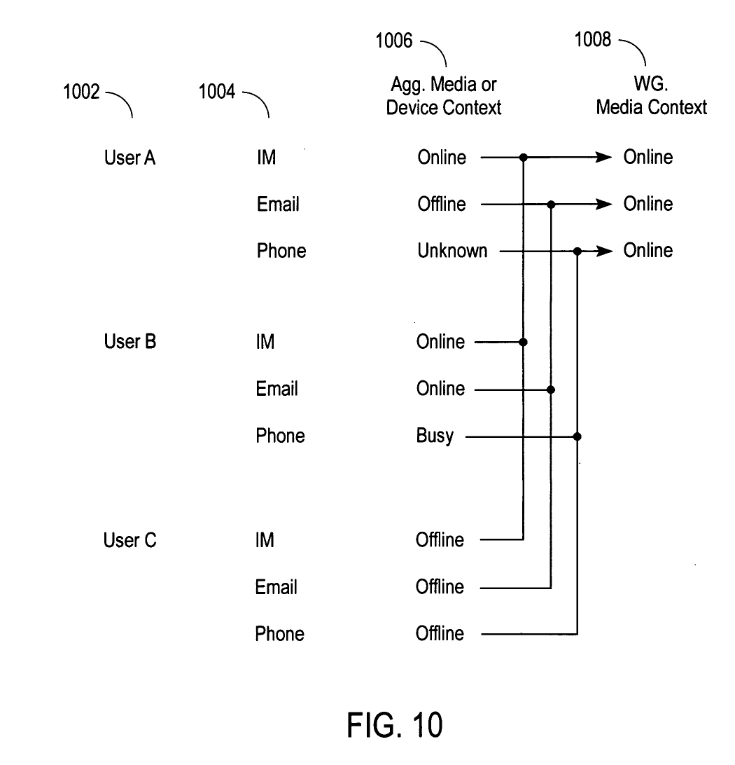

For example, FIG. 10 is a table illustrating exemplary workgroup context mapping according to embodiments of the present invention. Shown at column 1002 are exemplary members of the workgroup, User A, User B, User C. In the example illustrated, each user has Instant Messaging (IM), E-mail, and Telephone capabilities, as shown in Column 1004. Exemplary presence status, e.g., device or aggregated media contexts are shown in Column 1006; corresponding workgroup contexts are shown in column 1008. It is noted that, while e-mail, telephone, and instant messaging are shown, the invention is not limited to the media illustrated. Thus, the figure is exemplary only.

As shown, User A's IM is Offline, User B's IM is Online, and User C's IM is Offline. According to the at least one party rule, the workgroup context is mapped to Online, i.e., available to receive Instant Messaging. Similarly, user A's e-mail is Offline, User B's email is online, and user C's email is Offline. According to the at least one user rule, the workgroup context is online, i.e., the workgroup is available for e-mail. Finally, User A's phone is unknown, user B's phone is Busy and user C's phone is online. Thus, the workgroup telephone context is online, i.e., the workgroup is available for telephone calls.

It is noted that, while each individual media type may generate a workgroup presence status, in certain embodiments, a workgroup media presence value across plural media types may be provided. For example, if a user is either Online with respect to Instant Messaging or Email, he may be deemed to be Online or Online with respect to “Internet.”

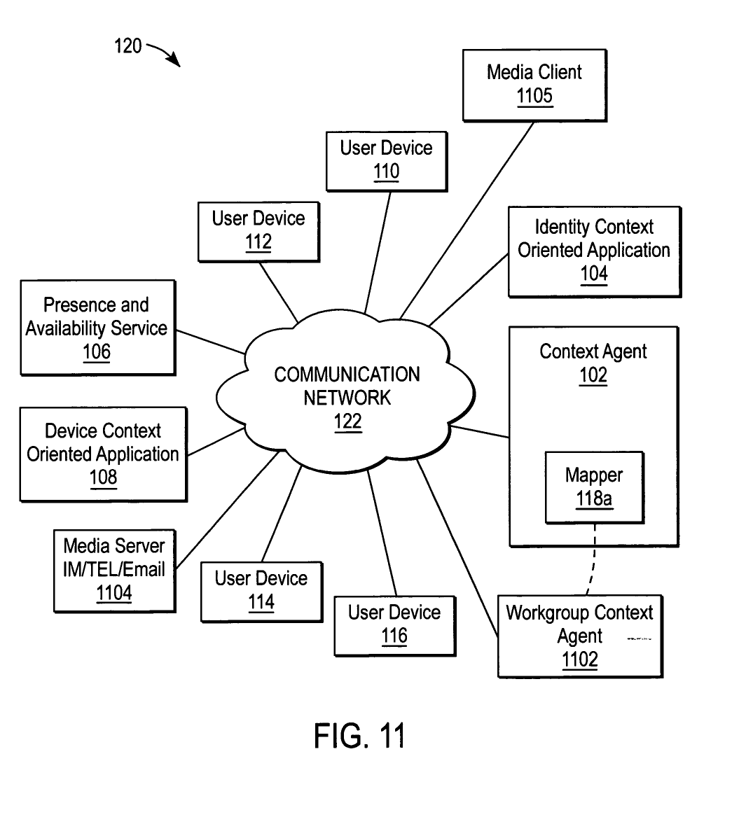

FIG. 11 is a block diagram of an exemplary system in accordance with embodiments of the present invention. Generally similar to the system of FIG. 1 and FIG. 2, the system 1120 may include a media server 1104, for implementing one or more media server functions, such as Instant Messaging, Telephony and/or E-mail. In addition, a workgroup context agent or control unit 1102 may be provided. The workgroup context agent 1102 and mapper 118a may operate in conjunction with the presence and availability service 106 and the context agent 102 to provide workgroup context information and mapping of device and/or identity context information to workgroup context information. It is noted that in certain embodiments, the workgroup context agent can be embedded in the “standard” context agent. Also, the context agent or the workgroup context agent may be used to determine the aggregated media context. Also, a media client application 105 may be provided that can be used to set the workgroup and user context information and/or receive the presence context information. Such a media client may be further be embodied as an identity context oriented application or a device context oriented application.

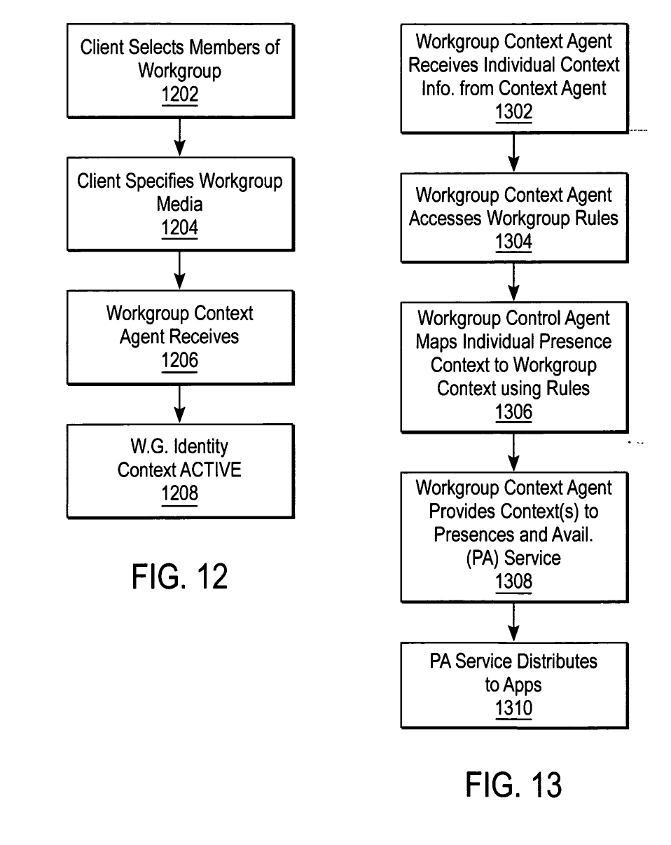

Reference is now made to FIG. 12, where a flowchart 1200 is shown which represents the operation of an embodiment of the present invention. The particular arrangement of elements in the flowchart 1200 is not meant to imply a fixed order to the elements; embodiments can be practiced in any order that is practicable.

In a step 1202, a party, such as the system administrator or the user or client device, such as media client 105, selects members of a workgroup. For example, a user may employ a media client program equipped with a suitable graphical user interface to select the members of the workgroup, for example, by choosing from a list of authorized network users via a browser interface, a list from an address book, by manually entering identifiers, such as phone numbers or e-mail addresses, or any other method of selecting or receiving the list of the members. An exemplary system in which a user can set a workgroup is the Openscape system, available from Siemens Information and Communication Networks, Inc.

In a step 1204, the client device 105 can be used to specify workgroup media, i.e., which media associated with the users are to be included in the workgroup. A default value may be “All media.” Again, this may be done through specifying and/or receiving lists of users, or by manually specifying identifiers. Also, thresholds for availability may be set. In a step 1206, the media server 1104 and/or the workgroup context agent 1102 receive the workgroup information. The information may be stored, for example, in one or more lookup tables (not shown) for system use.

In a step 1208, the user device 105 may be used to set the workgroup context to Active. Thus, when the contexts of individual users and/or devices change, the workgroup context can be updated as well. It is noted that in certain embodiments, Active may be a system default value not requiring manual or user activation.

Reference is now made to FIG. 13, where a flowchart 1300 is shown which represents the operation of another embodiment. The particular arrangement of elements in the flowchart 1300 is not meant to imply a fixed order to the elements; embodiments can be practiced in any order that is practicable.

In a step 1302, the workgroup context agent 1102 receives context information on workgroup members from the context agent 102. In the examples discussed above, the context information is device context or aggregated media context information, although identity context information could also be used. Further, in certain embodiments, if identity context information is provided, it can be mapped to device context information prior to use by the workgroup context agent 1102.

In a step 1304, the workgroup context agent 1102 identifies the workgroup, the workgroup members and accesses the stored workgroup rules. As noted above, this information may be stored in one or more lookup tables.

In a step 1306, the workgroup context agent 1102 accesses the mapper 118a and uses the mapper 118a to map the individual device, aggregated media, and/or identity contexts for example, for the particular media, to workgroup contexts. As noted above, the mapper 118a performs the mapping according to the stored rules.

In a step 1308, the workgroup context agent 1102 provides the workgroup context to the presence and availability service 106. The presence and availability service then provides the workgroup context information to any applications, such as media client 105 or other user devices, that wish to know. As noted above, such user devices may include parties within the organization who wish to know. Once the presence context information is received, the users can know if/how to contact the workgroup and can contact them in accordance with the context.

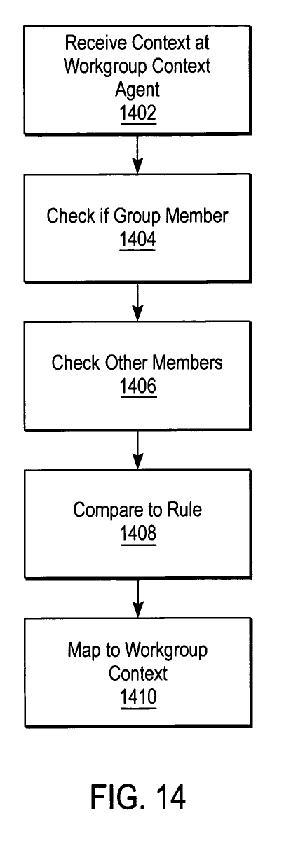

Reference is now made to FIG. 14, where a flow chart 1400 is shown which represents the operation of another embodiment. The particular arrangement of elements in the flow chart 1400 is not meant to imply a fixed order to the elements; embodiments can be practiced in any order that is practicable.

Initially, in a step 1402, the workgroup context agent 1102 receives one or more user contexts (e.g., device or aggregated media) from the context agent 102. For example, the workgroup context agent 1102 could receive the presence contexts periodically or when one member has changed context. In a step 1404, the workgroup context agent 1102 determines if the contexts are from group members. For example, the workgroup context agent 1102 may access one or more lookup tables storing the information that were input by the user(s).

In a step 1406, the workgroup context agent 1102 checks the contexts of the other members of the workgroup. In certain embodiments, the workgroup context agent 1102 will do so only for the medium specified. In a step 1408, the workgroup context agent 1102 compares the workgroup members' contexts to the workgroup rules. Finally, in a step 1410, the workgroup context agent 1102 will map the workgroup context in accordance with the rules.

Clients and Server

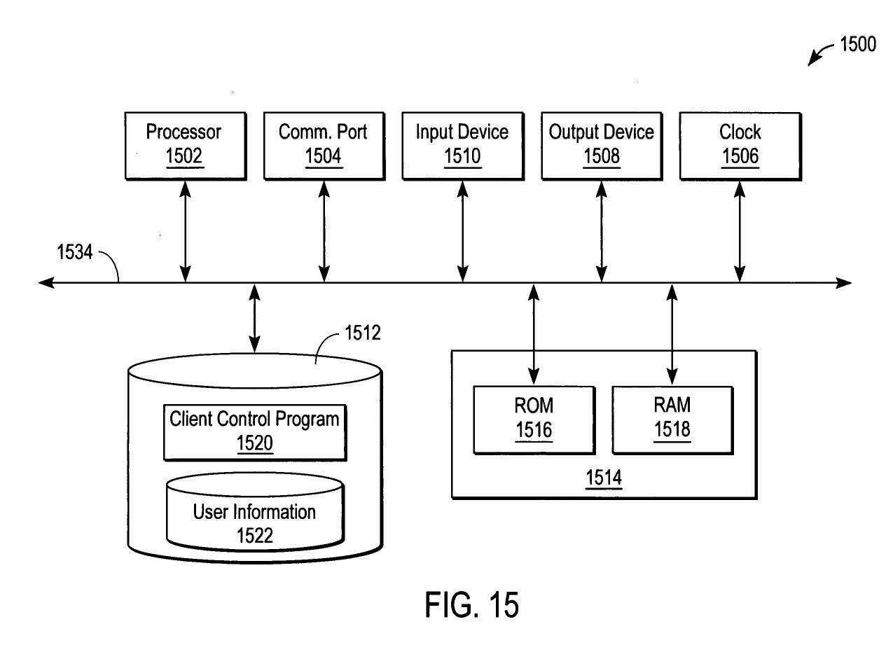

Now referring to FIG. 15, a representative block diagram of a computer or processing device 1500 suitable for use as a user device or media client according to embodiments of the present invention is shown. In some embodiments, the computer 1500 may include or operate a media client and/or context-oriented applications that receive presence context information. The computer 1500 may be embodied as a single device or computer, a networked set or group of devices or computers, a workstation, mainframe or host computer, etc. In some embodiments, the computer 1500 may implement one more elements of the methods disclosed herein.

The computer 1500 may include a processor, microchip, central processing unit, or computer 1502 that is in communication with or otherwise uses or includes one or more communication ports or network interfaces 1504 for communicating with user devices and/or other devices. The communication ports 1504 may include such things as local area network adapters, wireless communication devices, Bluetooth technology, etc. The computer 1500 also may include an internal clock element 1506 to maintain an accurate time and date for the computer 1500, create time stamps for communications received or sent by the computer 1500, etc.

If desired, the computer 1500 may include one or more output devices 1508 such as a printer, infrared or other transmitter, antenna, audio speaker, display screen or monitor, text to speech converter, etc., as well as one or more input devices 1510 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the computer 1500 may include a memory or data storage device 1512 to store information, software, databases, documents, communications, device drivers, etc. The memory or data storage device 1512 may be implemented as an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. Thus, the storage device 1512 may include various combinations of moveable and fixed storage. The computer 1500 also may include memory 1514, such as ROM 1516 and RAM 1518.

The processor 1502 and the data storage device 1512 in the computer 1500 each may be, for example: (i) located entirely within a single computer or other computing device; or (ii) connected to each other by a remote communication medium, such as a serial port cable, telephone line or radio frequency transceiver. In one embodiment, the computer 1500 may be implemented as one or more computers that are connected to a remote server computer, as will be explained in greater detail below.

A conventional personal computer or workstation with sufficient memory and processing capability may be used as the computer 1500. The computer 1500 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 1502. Other suitable processors may be available from Motorola, Inc., AMD, or Sun Microsystems, Inc. The processor 1502 also may be embodied as one or more microprocessors, computers, computer systems, etc.

Software may be resident and operating or operational on the computer 1500. The software may be stored on the data storage device 1512 and may include a client control program 1520 for operating the computer. The client control program 1520 may be used to set presence contexts and define workgroups, as discussed above.

The client control program 1520 may control the processor 1502. The processor 1502 may perform instructions of the client control program 1520, and thereby operate in accordance with the methods described in detail herein. The client control program 1520 may be stored in a compressed, uncompiled and/or encrypted format. The client control program 1520 furthermore includes program elements that may be necessary, such as an operating system, a database management system and device drivers for allowing the processor 1502 to interface with peripheral devices, databases, etc. Appropriate program elements are known to those skilled in the art, and need not be described in detail herein.

The computer 1500 also may include or store user information 1522 information regarding identities, user devices, contexts, presence information, communications, etc. In addition, the client control program 1520 may be used to control various media, such as telephony, Instant Messaging, E-mail, and the like; the user information thus may include addresses and other identifiers, messages, etc.

According to some embodiments, the instructions of the control program 1520 may be read into a main memory from another computer-readable medium, such as from the ROM 1516 to the RAM 1518. Execution of sequences of the instructions in the control program causes the processor 1502 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 1502, communication ports 1504, clock 1506, output device 1508, input device 1510, data storage device 1512, ROM 1516 and RAM 1518 may communicate or be connected directly or indirectly in a variety of ways. For example, the processor 1502, communication ports 1504, clock 1506, output device 1508, input device 1510, data storage device 1512, ROM 1516 and RAM 1518 may be connected via a bus 1534.

While specific implementations and hardware/software configurations for the computer 1500 have been illustrated, it should be noted that other implementations and hardware configurations are possible and that no specific implementation or hardware/software configuration is needed. Thus, not all of the components illustrated in FIG. 15 may be needed for the computer 1500 implementing the methods disclosed herein.

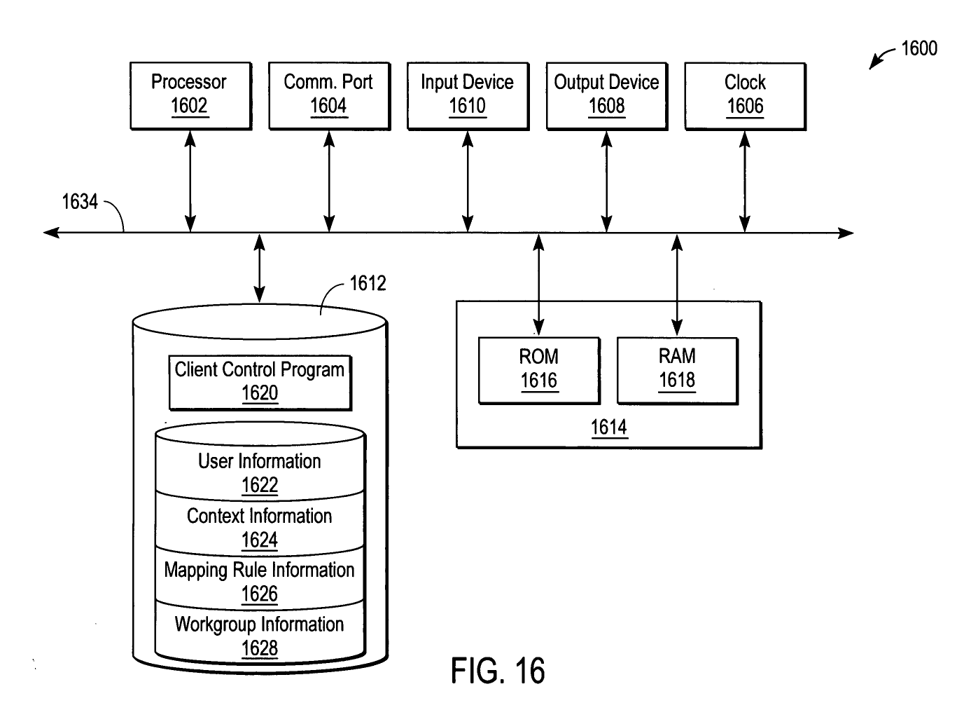

Now referring to FIG. 16, a representative block diagram of a server or controller 1600 is illustrated. In some embodiments, the server 1600 may include or operate an identity context oriented application, a device context oriented application, the context agent 102, the mapper 118, the mapper 118a, the workgroup context agent 1102, and/or the presence and availability service 106. The server 1600 can be implemented as a single device or computer, a networked set or group of devices or computers, a workstation, mainframe or host computer, etc. In some embodiments, the server 1600 may implement one more elements of the methods disclosed herein.

The server 1600 may include a processor, microchip, central processing unit, or computer 1602 that is in communication with or otherwise uses or includes one or more communication ports 1604 for communicating with user devices and/or other devices. Communication ports 1604 may include such things as local area network adapters, wireless communication devices, Bluetooth technology, etc. The server 1600 also may include an internal clock element 1606 to maintain an accurate time and date for the server 1600, create time stamps for communications received or sent by the server 1600, etc.

If desired, the server 1600 may include one or more output devices 1608 such as a printer, infrared or other transmitter, antenna, audio speaker, display screen or monitor, text to speech converter, etc., as well as one or more input devices 1610 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 1600 may include a memory or data storage device 1612 to store information, software, databases, documents, communications, device drivers, etc. The memory or data storage device 1612 preferably comprises an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. The server 1600 also may include separate ROM 1616 and RAM 1618.

The processor 1602 and the data storage device 1612 in the server 1600 each may be, for example: (i) located entirely within a single computer or other computing device; or (ii) connected to each other by a remote communication medium, such as a serial port cable, telephone line or radio frequency transceiver. In one embodiment, the server 1600 may comprise one or more computers that are connected to a remote server computer for maintaining databases.

A conventional personal computer or workstation with sufficient memory and processing capability may be used as the server 1600. The server 1600 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 1602. Equivalent or other processors may be available from Motorola, Inc., AMD, or Sun Microsystems, Inc. The processor 1602 also may comprise one or more microprocessors, computers, computer systems, etc.

Software may be resident and operating or operational on the server 1600. The software may be stored on the data storage device 1612 and may include a control program 1612 for operating the server, databases, etc. The control program 1612 may control the processor 1602. The processor 1602 preferably performs instructions of the control program 1612, and thereby operates in accordance with the methods described in detail herein. The control program 1612 may be stored in a compressed, uncompiled and/or encrypted format. The control program 1612 furthermore includes program elements that may be necessary, such as an operating system, a database management system and device drivers for allowing the processor 1602 to interface with peripheral devices, databases, etc. Appropriate program elements are known to those skilled in the art, and need not be described in detail herein.

The server 1600 also may include or store information regarding identities, user devices, contexts, mapping tables, communications, etc. For example, information regarding one or more identities may be stored in an identity information database 1622 for use by the server 1600 or another device or entity. Information regarding one or more identity or device contexts may be stored in a context information database 1624 for use by the server 1600 or another device or entity and information regarding one or more context mapping rules may be stored in a context mapping information database 1626 for use by the server 1600 or another device or entity. In some embodiments, some or all of one or more of the databases may be stored or mirrored remotely from the server 1600. Information regarding workgroup members, etc., may be stored in database 1626.

According to some embodiments, the instructions of the control program may be read into a main memory from another computer-readable medium, such as from the ROM 1616 to the RAM 1618. Execution of sequences of the instructions in the control program causes the processor 1602 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 1602, communication port 212, clock 214, output device 1608, input device 1610, data storage device 1612, ROM 1616, and RAM 1618 may communicate or be connected directly or indirectly in a variety of ways. For example, the processor 1602, communication port 1604, clock 1606, output device 1608, input device 1610, data storage device 1612, ROM 1616, and RAM 1618 may be connected via a bus 1634.

While specific implementations and hardware/software configurations for the server 1600 have been illustrated, it should be noted that other implementations and hardware configurations are possible and that no specific implementation or hardware/software configuration is needed. Thus, not all of the components illustrated in FIG. 16 may be needed for the server 1600 implementing the methods disclosed herein.

The methods described herein may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, in some embodiments, many, if not all, of the elements for the methods described above are optional or can be combined or performed in one or more alternative orders or sequences and the claims should not be construed as being limited to any particular order or sequence, unless specifically indicated.

Each of the methods described above can be performed on a single computer, computer system, microprocessor, etc. In addition, in some embodiments, two or more of the elements in each of the methods described above could be performed on two or more different computers, computer systems, microprocessors, etc., some or all of which may be locally or remotely configured. The methods can be implemented in any sort or implementation of computer software, program, sets of instructions, programming means, code, ASIC, or specially designed chips, logic gates, or other hardware structured to directly effect or implement such software, programs, sets of instructions, programming means or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although methods and systems have been described with respect to various embodiments thereof, those skilled in the art will note that various substitutions may be made to those embodiments described herein. The invention described in the above detailed description is not intended to be limited to the specific form set forth herein, but is intended to cover such alternatives, modifications and equivalents as can reasonably be included within the spirit and scope of the appended claims.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

1. A method, comprising:
defining a workgroup;
receiving one or more user presence contexts for users in said workgroup; and
deriving a workgroup presence context from said one or more user contexts.

2. A method in accordance with claim 1, wherein said deriving comprises evaluating a presence status of a predetermined number of members of said workgroup.

3. A method in accordance with claim 2, wherein said evaluating a presence status comprises evaluating a media presence value for individual media types.

4. A method in accordance with claim 2, wherein said evaluating a presence status comprises evaluating an aggregated media presence value for a user.

5. A method in accordance with claim 2, further comprising making the workgroup presence information available to all members of the workgroup.

6. A telecommunications system, comprising:
a plurality of user devices defining a workgroup;
a presence server configured to monitor presence contexts of said plurality of users, said presence server including a workgroup presence control unit configured to monitor a workgroup presence, said workgroup presence derived from user presence contexts.

7. A telecommunications system in accordance with claim 6, wherein a workgroup presence is defined by a user presence of a predetermined number of user devices.

8. A telecommunications system in accordance with claim 7, wherein said predetermined number is user-programmable.

9. A telecommunications system in accordance with claim 7, wherein a workgroup presence is defined over a particular medium.

10. A telecommunications system in accordance with claim 7, wherein a workgroup presence is defined over a plurality of media.

11. An apparatus, comprising:
a processor;
a communication port coupled to said processor and adapted to communicate with at least one device; and
a storage device coupled to said processor and storing instructions adapted to be executed by said processor to translate a plurality of user device contexts, the user contexts defining user presence states, into a workgroup context.

12. An apparatus in accordance with claim 11, wherein a workgroup context is defined by the presence states of a predetermined number of user contexts.

13. An apparatus in accordance with claim 12, wherein said predetermined number is more than half.

14. An apparatus in accordance with claim 11, wherein user contexts include Offline, Unknown, Online, or Busy.

15. An apparatus in accordance with claim 14, wherein a workgroup context includes Offline, Unknown, Online, or Busy.

16. An apparatus in accordance with claim 15, wherein a workgroup context is defined to be Online if a predetermined number of the user members of the workgroup are Online.

17. An apparatus in accordance with claim 15, wherein a workgroup context is defined to be Offline if a predetermined number of the user members of the workgroup are Offline.

18. An apparatus in accordance with claim 15, wherein a workgroup context is defined to be Unknown if a predetermined number of the user members of the workgroup are Unknown.

19. An apparatus in accordance with claim 15, wherein a workgroup context is defined to be Busy if a predetermined number of the user members of the workgroup are Busy.
